(19) United States
(12) Patent Application Publication
(10) Pub. No.: US 2026/0294604 A1
(43) Pub. Date: Oct. 1, 2026

(54) ELECTRIC TOOTHBRUSH AND METHOD OF FORMING THE SAME

(71) Applicant: Quip NYC Inc., Brooklyn, NY (US)

(72) Inventors: Nathan HERRMANN, San Mateo, CA (US); Michael J. LAWLOR, Brooklyn, NY (US)

(21) Appl. No.: 19/095,678

(22) Filed: Mar. 31, 2025

(51) Int. Cl. A61C 17/22; A46B 5/00; A46B 5/02; A46B 13/02; A46B 15/00; A46D 3/00

(52) U.S. Cl. CPC A61C 17/225; A46B 5/0095; A46B 5/026; A46B 13/02; A46B 15/0004; A46D 3/00

(57) ABSTRACT

In an electric toothbrush, a handle component includes a first housing portion and a second housing portion. A first end coupling portion and a second end coupling portion are locatable in the second housing portion. The first end coupling portion is engageable with the first housing portion. The second end coupling portion has an opening. A motor is receivable within the second housing portion. A shaft is receivable within the handle component via the opening in the second end coupling portion. The shaft is selectively operatively engageable with the motor when disposed within the second housing portion. A head is selectively operatively engageable with the shaft and configured to interoperate with a bristle pod. At least a portion of the second housing portion of the handle component and at least a portion of the shaft are selectively receivable within a sleeve, so as to be at least partially encompassed therewithin.

### TECHNICAL FIELD

Aspects of the present disclosure describe various features relating to electric toothbrushes.

### BACKGROUND

Toothbrushing is important for maintaining good oral health. A toothbrush typically includes a cleaning element and a handle coupled to one another via a shank. The cleaning element typically includes a plurality of bristles. With toothpaste applied to the plurality of bristles of the cleaning head, in use, for example, a user may grasp the handle to move the shank and, thereby, enable the plurality of bristles in the user’s mouth to be used to clean the user’s teeth, gum, and tongue. Although manual toothbrushes may be used to clean teeth, electric toothbrushes may facilitate achieving superior and more consistent cleaning, potentially reducing incidences of dental diseases.

In related examples of toothbrush features and use, a handle of an electric toothbrush may include a housing and a sleeve to cover the housing. Assembly challenges may exist when the sleeve (e.g., a silicone layer) is assembled with the housing of the handle. Assembly challenges may also exist when a top portion of the housing and a bottom portion of the housing are assembled to each other.

### SUMMARY

Aspects of the disclosure include an electric toothbrush and a method of forming the same.

According to an aspect of the disclosure, an example electric toothbrush is provided. The example electric toothbrush may include a handle. The handle may include a first housing portion and a second housing portion. A first end coupling portion of the second housing portion may be operatively engaged with the first housing portion for assembly. The electric toothbrush may include a shaft that extends from a second end coupling portion of the second housing portion of the handle, which may be attachable to and selectively operably engageably with a motor that may be disposed, for example, in the second housing portion of the handle. The electric toothbrush may include a head that is selectively engageably attachable to the shaft, which may include or be further engageable with, a bristle pod. The electric toothbrush may include a sleeve covering, for example, (i) the second housing portion of the handle and (ii) the shaft of the electric toothbrush.

In an aspect, the first housing portion and the second housing portion may comprise a material that is less flexible or resilient than a material comprising at least some portions of the sleeve.

In an example aspect, at least some features of the first housing portion and the second housing portion may comprise of materials that include one of nylon, glass filled nylon, acrylonitrile butadiene styrene (ABS), and polycarbonate, while features of the sleeve may comprise materials that include one of a silicone and/or a thermoplastic elastomer (TPE) material.

In an aspect, the electric toothbrush may include a switch button (e.g., a selectably engagable button) that is configured to enable selective operation of the electric toothbrush and may be positionable proximal to a depressable biased connector (also interchangeably referred to as a “diving board”) located, for example, on the second housing portion of the handle. The depressable biased connector may be configured to operate, for example, via or in conjunction with, a corresponding opening located in the second housing portion, such that a circuit board contact or other switch operable feature in the second housing portion is readily engageable via the opening.

In an aspect, the switch button may be receivable in a sleeve, with a portion of the sleeve extending through the depressable biased connector of the second housing portion to enable, for example, in one example implementation, the depressable biased connector to make direct contact with a circuit board to cause a switch to operate. The circuit board may be coupled to the motor of the electric toothbrush and thereby be configured to enable selective operation of the motor.

In an aspect, the switch button may comprise a TPE material, for example, that may be receivable within the sleeve. The TPE material may extend through the depressable biased connector of the top housing so as to enable the depressable biased connector to be contactable or otherwise engageable with one or more features of circuit board when a compression force is applied to the switch button.

In one example implementation, a gap may extend between (i) the sleeve and (ii) the switch button and the depressable biased connector of the top housing when the switch in in an unengaged position.

In an aspect, the sleeve and the first housing portion may comprise two different materials.

In an aspect, the sleeve may include a first end coupling portion, at which or proximal to, the head may be located, and a second end coupling portion operatively engageable with the first housing portion of the handle when the toothbrush is fully assembled.

In an aspect, an extension length of the first housing portion may be approximately equal to or larger than an extension length of the second housing portion of the handle.

According to another aspect of the disclosure, a method of manufacturing an electric toothbrush is provided. In the method, a handle may be formed or assembled. The handle may include a first housing portion and a second housing portion. A first end coupling portion may be assembleably engaged with the second housing portion in order to assemble the first and second housing portions with one another. A shaft may be located so as to extend from a second end coupling portion of the second housing portion of the handle at a first shaft end and be engageably attached at a second shaft end to a motor that is disposed in the first housing portion of the handle. A sleeve may be formed to cover (i) the second housing portion of the handle and (ii) the shaft of the electric toothbrush. A first end coupling portion of the sleeve may be in contact with the first housing portion upon assembly. A head may be encompassed in a second end coupling portion of the sleeve. The head may include a bristle pod and be engageably attachable to the shaft.

In an aspect, a switch button (e.g., selectably engagable button) that may be configured to control operation of the electric toothbrush may be located proximal to a depressable biased connector on the second housing portion of the handle. The depressable biased connector may be configured to extend within an opening in the second housing portion, such that a circuity board in the second housing portion proximal to the depressable biassed connector may be readily engageable via the opening.

In an aspect, the switch button may be configured to operate via the depressable biased connector in conjunction with contact with a portion of the sleeve. For example, a portion of the sleeve may extend between the depressable biased connector and the second housing portion to enable direct activation therethrough of a feature on the circuit board. The circuit board may thereby enable selective operation of the motor.

In an aspect, the switch button may comprise a TPE material.

In an aspect, the first housing portion and the second housing portion may comprise a material more rigid than the material of the sleeve.

In an aspect, the first housing portion and the second housing portion may include one of nylon, glass filled nylon, and polycarbonate, and the sleeve may comprise one or more of silicone and a TPE material.

In an aspect, a gap may extend between (i) the sleeve and (ii) the switch button and the depressable biased connector of the second housing portion.

In an aspect, the sleeve and the first housing portion may be made of two different materials.

In an aspect, an extension length of the first housing portion may be approximately equal to or greater than an extension length of the second housing portion of the handle.

In an aspect, a depressable biased connector may be formed or located in the second housing portion of the handle. The depressable biased connector may include one or more openings that may expose a circuit board in the second housing portion, a pad portion positionable proximal to a center of the opening, and a plurality of extensions or legs in contact with the pad and an edge of the opening.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

Further features, the nature, and various advantages of the disclosed subject matter will be more apparent from the following detailed description and the accompanying drawings in which:

FIG. 1 is a front view of an electric toothbrush according to some aspects of the disclosure.

FIG. 2 is a first cross-sectional view of the electric toothbrush of FIG. 1 according to some aspects of the disclosure.

FIG. 3 is a second cross-sectional view of the electric toothbrush of FIG. 1 according to some aspects of the disclosure.

FIGS. 4A and 4B are expanded views of a flexible depressable biased connector of the electric toothbrush of FIG. 1 according to some aspects of the disclosure.

FIG. 5A is a cross-sectional view of an electric toothbrush according to some aspects of the disclosure.

FIG. 5B is a perspective view of the electric toothbrush of FIG. 5A according to some aspects of the disclosure.

FIG. 6A is a cross-sectional view of an electric toothbrush according to some aspects of the disclosure.

FIGS. 6B and 6C are expanded views of the electric toothbrush of FIG. 6A according to some aspects of the disclosure.

FIGS. 7A and 7B are perspective views of the electric toothbrush of FIG. 6A according to some aspects of the disclosure.

FIG. 8 is a cross-section view of another example of an electric toothbrush according to some aspects of the disclosure.

FIG. 9 shows a flow chart of manufacturing an electric toothbrush according to some aspects of the disclosure.

### DETAILED DESCRIPTION

Embodiments will now be described more fully hereinafter with reference to the accompanying figures, in which exemplary embodiments are shown. The foregoing may, however, be embodied in many different forms and should not be construed as limited to the exemplary embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

In the description that follows, devices, systems, and methods are generally described in the context of electric toothbrushes for the sake of clear and efficient description of various features. Unless otherwise specified or made clear from the context, it should be more generally understood that devices, systems, and methods described herein may be used in the context of other types of dental care devices. Thus, for example, unless a contrary intent is explicitly set forth, the devices, systems, and methods described herein may be used in the context of oral irrigators. Further, or instead, unless otherwise specified or made clear from the context, aspects of toothbrushes described herein may be implemented as manual toothbrushes.

Further, or instead, unless otherwise specified or made clear from the context, the term “mechanical communication” is used herein to refer to both direct mechanical coupling between two components and to indirect mechanical coupling between two components. The term “electrical communication” is used herein to refer to both direct electrical coupling between two components and to indirect electrical coupling between two components. In an example, two components shall be understood to be in mechanical communication with one another via indirect mechanical coupling in which one or more components are between the two components but mechanical force is transmitted between the two components that are indirectly mechanically coupled to one another. As a specific example, two components shall be understood to be in mechanical communication with one another, even with gaskets or other types of components disposed between the two components, provided that at least some mechanical force is intended to be transmitted in at least one direction between the two components.

For the sake of clear and efficient description, elements with numbers having the same last two digits in the disclosure that follows shall be understood to be analogous to or interchangeable with one another, unless otherwise explicitly stated or made clear from the context and, therefore, are not described separately from one another, except to note difference or to emphasize certain features. Thus, for example, a sleeve 112 of an electric toothbrush 100 and a sleeve 212 of an electric toothbrush 200 shall be understood to be analogous to or interchangeable with one another, unless otherwise specified or made clear from the context.

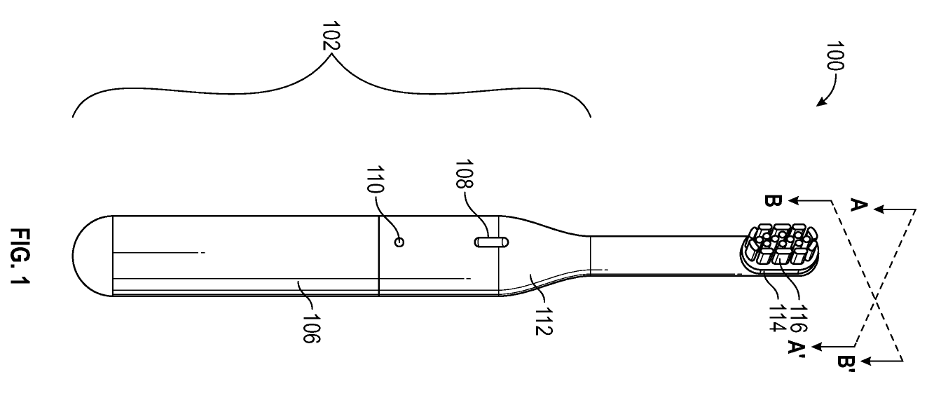

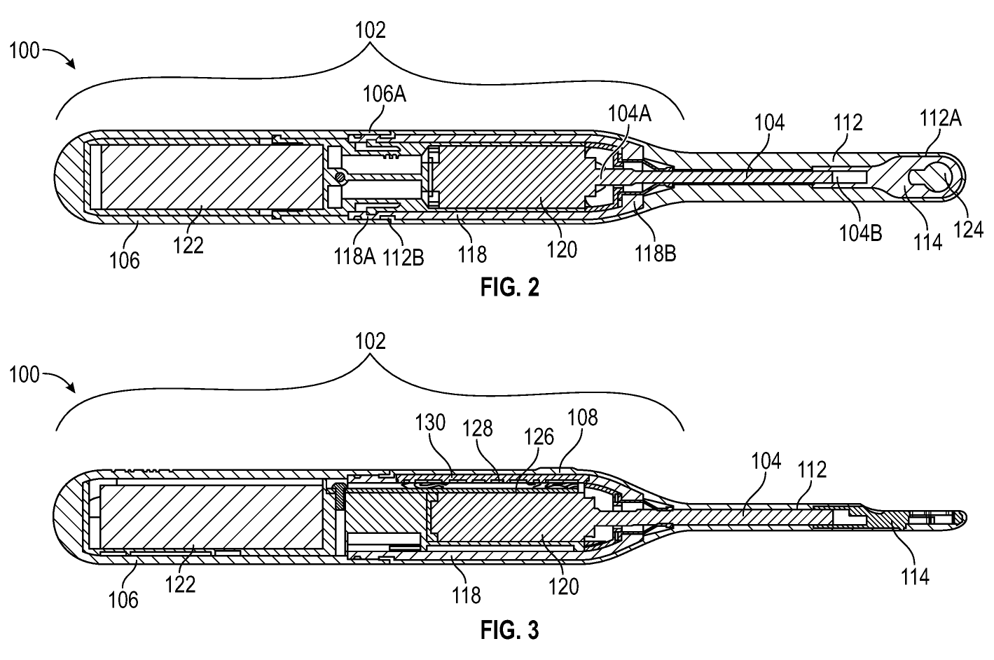

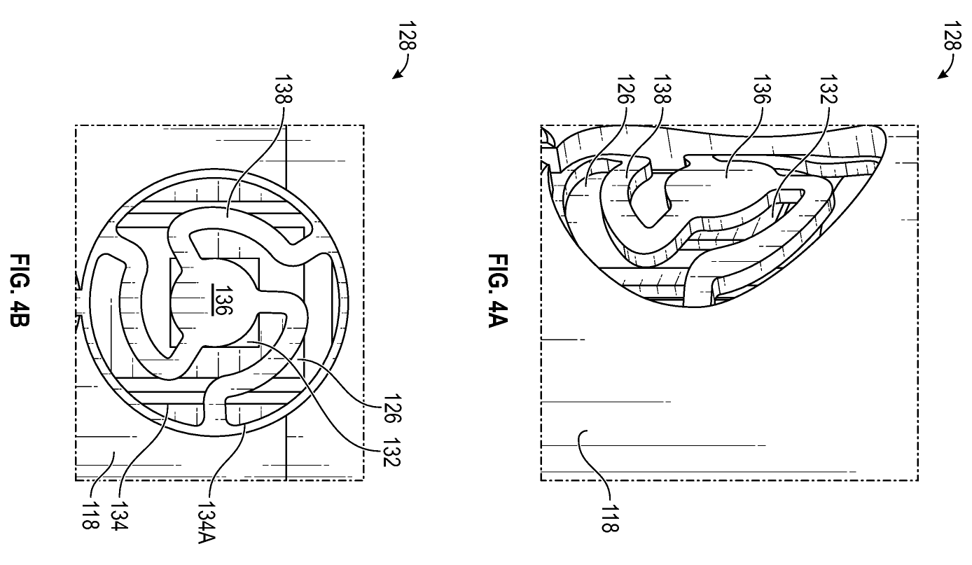

FIGS. 1-3 show various features of an example electric toothbrush 100 in accordance with aspects of the present disclosure. The electric toothbrush 100 as shown in FIGS. 1-3 includes a handle portion (or a handle) 102, a shaft portion (or a shaft) 104 (FIGS. 2 and 3) extending from the handle portion 102, and a head 114. The handle 102 includes a first (or bottom) housing portion 106 and a second (or top) housing portion (e.g., 118 in FIG. 2) engageably attachable to the first housing portion 106. The electric toothbrush 100 includes a sleeve 112 covering (i) the second housing portion 118 of the handle 102 and (ii) the shaft 104 of the electric toothbrush 100, as best shown in cross-section in FIG. 2. The head 114 is coupleable to (or selectively engageably attachable to) the shaft 104 (as best shown in FIG. 2) and includes a bristle pod 116 (as best shown in FIG. 1). The bristle pod 116 may function as a cleaning element of the electric toothbrush 100.

In an example implementation, the bristle pod 116 may be replaceably inserted into the head 114, such as via aperture 124 shown in FIG. 2. Thus, the bristle pod 116 (FIG. 1) is exchangeable. The electric toothbrush 100 may also include a switch button 108 (FIG. 1) that is configured to selectively control operation of the electric toothbrush 100. The switch button 108 may be located at a suitable position (such as for selective activation by a user’s thumb or finger) within the housing section of the handle 102, such as at the position shown in FIG. 1, and may be covered by the sleeve 112. The electric toothbrush 100 may also include an indicator 110 (FIG. 1), such as a light-emitting diode (LED). The indicator 110 may indicate a battery status. For example, the indicator 110 may provide a low battery warning or a charging status. The indicator 110 may also provide a mode indication. For example, the LED of the indicator 110 may visually display of a selected mode (e.g., clean, sensitive, whitening). The indicator 110 may also serve as a display of a pressure sensor. For example, the LED of the indicator 110 may indicate if the brushing is too hard. The indicator 110 may be a timer to display a brushing time for a user. The indicator 110 may also or alternatively be an indicator of a wireless connectivity, such as a Bluetooth connectivity, and/or to indicate a successful connection to an app (e.g., a smartphone app). The various functions described above in the indicator 110 may be indicated by different colors, brightnesses, or blinking modes provided by the indicator 110, for example. In an example implementation, different colors may indicate different battery statuses. For example, a solid green may indicate a fully charged status, a flashing green may indicate a partially charged status, and a red color may indicate a low battery status. In an example implementation, different colors may indicate different pressures. For example, a green color may indicate a normal brushing pressure, a yellow color may indicate a moderate pressure, a red color may indicate an excessive pressure, and a rapid blinking may indicate a consistently high pressure. In an example implementation, the indicator 110 may blink or change color to remind a user to move to a different quadrant of the mouth.

FIG. 2 is a cross-sectional view of the electric toothbrush 100 along a vertical plane through line A-A’ in FIG. 1. As shown in FIG. 2, the handle 102 includes the second housing portion 118 assembled with the first housing portion 106. In an example implementation, a first end coupling portion 118A of the second housing portion 118 may be inserted into or otherwise be receivably engaged with the first housing portion 106, such as via a mating coupling portion 106A of the first housing portion 106. In an example implementation, the mating coupling portion 106A of the first housing portion 106 may be inserted into the first end coupling portion 118A of the second housing portion 118 or otherwise be receivably engaged with the second housing portion 118. The shaft 104 may extend from a second end coupling portion 118B of the second housing portion 118 and be operatively engageable with a motor 120. The motor 120 may be disposed within a cavity within the second housing portion 118 and configured to selectively drive rotation of the shaft 104. The sleeve 112 may be arranged to cover (i) at least a portion of the second housing portion 118 of the handle 102 and (ii) the shaft 104 of the electric toothbrush 100. The sleeve 112 may include a first end 112A, which may partially or fully encompass the head 114 and a second end 112B, which may contact, and/or have received therewithin, a portion of the first housing portion 106.

In an example implementation shown in FIG. 2, the second end 112B of the sleeve 112 is arranged to be located between the first end coupling portion 118A of the second housing portion 118 and the mating coupling portion 106A of the first housing portion 106. Thus, sealing of at least a portion of the electric toothbrush 100 may be accomplished thereby.

The head 114 may include the aperture 124, in which the bristle pod 116 may be receivable. The electric toothbrush 100 may also include a power source, such as a rechargeable battery, 122 disposed in a volume defined by the first housing portion 106. The power source 122 (e.g., a rechargeable battery) may be in selective electrical communication with the motor 120 to so as to selectively thereby power the motor 120. In an example implementation, the power source 122 may be a lithium-ion battery or any suitable rechargeable battery. In addition, for example, the power source 122 may be wirelessly rechargeable. In another example implementation, the power source 122 may be charged via a wire. In an example implementation, a vent hole (not shown in FIG. 2) may be located at or near the first end coupling portion 118A of the second housing portion118 and/or at or near the mating coupling portion 106A of the first housing portion 106. The vent hole may be configured, for example, to release any gases generated by the power source 122 once a predetermined pressure level within the toothbrush 100 is reached.

In an example implementation, the motor 120 may be a sonic vibration motor actuatable to vibrate a first end portion 104A of the shaft 104 in the volume defined by the sleeve 112, and the shaft 104 may in turn transmit vibration of the first end portion 104A of the shaft 104 to the head 114 via a second end portion 104B of the shaft 104.

Further referring to the example implementation shown in FIG. 2, in an example implementation, the first housing portion 106 and the second housing portion 118 may be made in whole or in part from a harder material than the sleeve 112. In an example implementation, the first housing portion 106 and the second housing portion 118 may comprise one or more of nylon, glass filled nylon, acrylonitrile butadiene styrene (ABS), and/or polycarbonate, and the sleeve 112 may comprise one or more of a silicone and a thermoplastic elastomer (TPE) material. Further, in an example implementation, an extension length of the first housing portion 106 may be equal to or greater than an extension length of the second housing portion 118 of the handle 102.

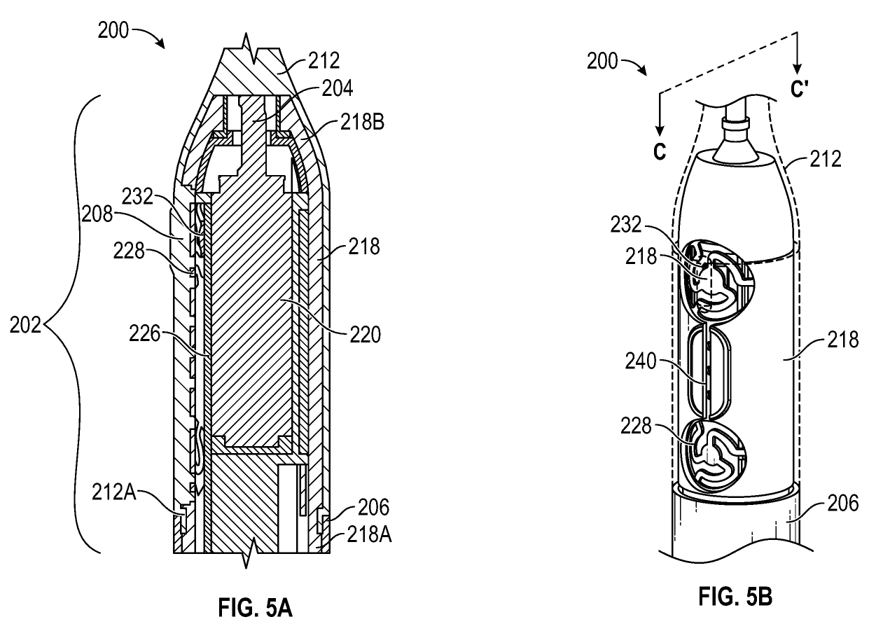

FIG. 3 is a cross-sectional view of the electric toothbrush 100 along the plane through line B-B’ as indicated in FIG. 1. As shown in FIG. 3, the electric toothbrush 100 includes a circuit board 126, such as a printed circuit board (PCB), disposed in the volume defined by the second housing portion 118 of the handle 102. The circuit board 126 may be positioned adjacent to (or proximal to) the second housing portion 118, for example, and may be placed in selective electrical communication with any one or more of the power source 122, the motor 120, charging coils (not shown in FIG. 3), sensors (not shown in FIG. 3), input components (not shown in FIG. 3), and/or output components (not shown in FIG. 3), which components may be included within or attached to the housing of the electric toothbrush 100. The circuit board 126 may, for example, included one or more processors (not shown in FIG. 3) and one or more non-transitory computer-readable storage media having stored thereon instructions for causing the one or more processors to carry out any one or more aspects of operation of the electric toothbrush 100 described herein. The circuit board 126 may be coupled to a touch sensor (e.g., 132 in FIGS. 4A and 4B), for example, such as a capacitive touch sensor, that is disposed adjacent to the switch button 108. A user may provide input to the touch sensor by touching (or pressing) the switch button 108. For example, the user may transmit the input by physically pressing the switch button 108 to cause a contact between the switch button 108 and the touch sensor. The touch sensor may correspondingly provide the input of the user to the circuit board 126, such that input received through the touch sensor may then be used to carry out any one or more of various operations of the electric toothbrush 100.

In an example implementation, the circuit board 126 may be placed in selective electrical communication with the motor 120, such that via the switch button 108 the circuit board 126 may thereby selectively control operation of the motor 120. In example operation, the circuit board 126 may receive a first user input from the capacitive touch sensor (e.g., 132 in FIGS. 4A and 4B) and to enable selective operation of the motor 120 based thereon. In an example implementation, the circuit board 126 may selectively disable a user input via the capacitive touch sensor based on the motor 120 being in an actuated state. For example, the circuit board 126 may receive a second user input from the capacitive touch sensor, and, based on the second user input, initiate a real-time clock countdown for a predetermined period set for a brushing session of the head 114, and to provide an alert to the user at the end of the predetermined period. In an example implementation, the circuit board 126 may determine a state of the motor 120 and control the LED indicator 110 based on a state of the motor 120. For example, the electric toothbrush 100 may further include a pressure sensor in mechanical and/or electrical communication with the shaft 104. The circuit board 126 may receive, from the pressure sensor, a signal indicative of pressure during a brushing session and to control the LED indicator 110 based on the pressure during the brushing session. For example, the circuit board 126 may provide feedback to the user with the pressure of brushing based on display of the LED indicator 110. In this regard, the pressure sensor may include a strain gauge, a pressure switch, or a combination thereof, for example.

Still referring to FIG. 3, the second housing portion 118 may include a depressable biased connector (or a diving board) 128. In an aspect, the depressable biased connector 128 may be positioned proximal to the switch button 108. The depressable biased connector 128 may be located within an opening in the second housing portion 118, such that the circuit board 126 and the touch sensor are readily engageable thereby, via the opening. In an example implementation, a gap 130 may be arranged between (i) the sleeve 112 and (ii) the depressable biased connector 128 of the second housing portion 118. Thus, the sleeve 112 may not be in direct contact with the circuit board 126 and/or the touch sensor.

FIGS. 4A and 4B show expanded views of various example features of the depressable biased connector 128. As shown in FIGS. 4A and 4B, the depressable biased connector 128 may include opening portions 134, a pad 136, a plurality of extensions or legs 138 connecting the pad 136 and an edge 134A of the opening 134. The opening 134 may have a generally circular shape, for example, as shown in FIG. 4B, or other suitable shape, such as a triangular shape, a rectangular shape, a square shape, or the like. The opening 134 may be configured to expose (or uncover) the circuit board 126 and the touch sensor 132, such that the circuit board 126 and the touch sensor 132 may be readily engageable via the opening 134. The pad 136 may be positioned at a center of the opening 134 and adjacent to the touch sensor 132, for example. The pad 136 and the plurality of extensions 138 may be flexible. Thus, a user may provide an input to the touch sensor 132 by pushing the pad 136. For example, the user may press the switch button (e.g., 108 in FIG. 1) to cause the switch button to push the pad 136. The pad 136 may be deformed correspondingly to apply a force on the touch sensor 132. The touch sensor 132 may be triggered by the force transmitted by the pad 136. The touch sensor 132 may further electrically communicate with the circuit board 126 to cause the circuit board 126 to carry out any one or more of various operations of the electric toothbrush 100 described herein.

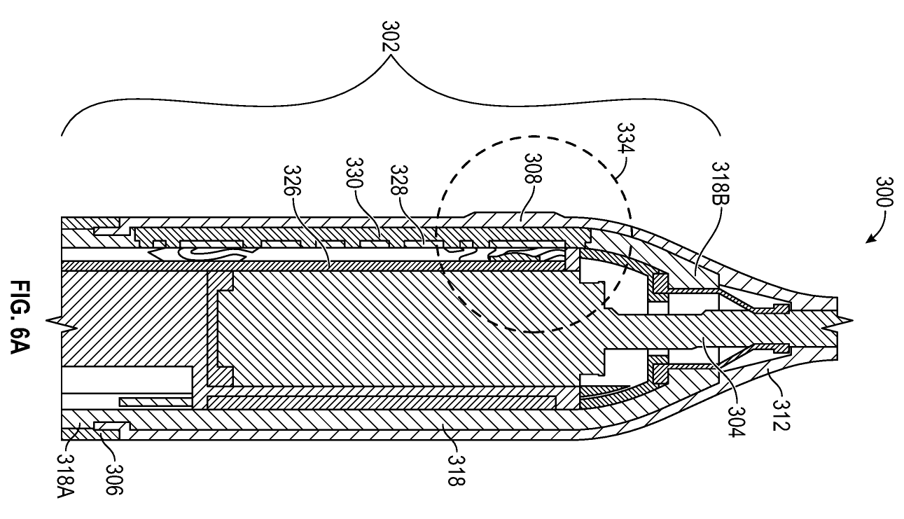

FIG. 5A is a cross-sectional view of an example electric toothbrush 200 according to aspects of the disclosure. FIG. 5B is a perspective view of the electric toothbrush 200 of FIG. 5A. The view of FIG. 5A is obtained along the plan through line C-C’ of the view shown in FIG. 5B.

As shown in FIG. 5A, the electric toothbrush 200 may include a handle 202. The handle 202 includes a first housing portion 206 and a second housing portion 218. The second housing portion 218 may be engageably attached to the first housing portion 206. In an example implementation as shown in FIG. 5A, upon assembly, a first end coupling portion 218A of the second housing portion 218 may be received within the first housing portion 206. The electric toothbrush 200 may include a motor 220 disposed in a cavity within the second housing portion 218. The electric toothbrush 200 may include a shaft 204 extending from a second end coupling portion 218B of the second housing portion 218. The electric toothbrush 200 may include a sleeve 212. The sleeve 212 may cover the shaft 204 and the second housing portion 218. The second housing portion 218 may include one or more depressable biased connectors 228 that may be configured to expose (or provide access to) one or more features of a circuit board 226 and/or a touch sensor 232. The sleeve 212 may further extend into openings in the one or more depressable biased connectors 228. Thus, the portion of the sleeve 212 corresponding to the positions of the one or more depressable biased connectors 228 may enable the depressable biased connector 228 to be in direct contact with the circuit board 226 and/or a touch sensor 232 and function as one or more switch buttons 208 when a compression force is applied to the one or more switch buttons 208. The one or more switch buttons 208 may be similar to the switch button 108 in FIG. 1. In an example of FIG. 5B, the second housing portion 218 may also include an opening 240. The opening 240 may expose (or provide access to) a display component (e.g., a LED displayer) coupled to the circuit board 226. The sleeve 212 may also penetrate the opening 240. The portion of the sleeve 212 corresponding to the position of the opening 240 may be in direct contact with the circuit board 226 and/or the display component (e.g., LED displayer), which may function as an indicator, such as a LED indicator similar to the indicator 110 in FIG. 1.

In an example process for manufacturing the electric toothbrush 200, the handle 202 may be assembled. The handle 202 may include the first housing portion 206 and a second housing portion 218. A first end coupling portion 218A of the second housing portion 218 may be engageably attached to, such as inserted into, the first housing portion 206 to thereby assemble the second housing portion 218 and the first housing portion 206 with one another. A shaft 204 may be positioned so as to extend from a second end coupling portion 218B of the second housing portion 218 of the handle 202 and be operatively enganged with a motor 220 positioned in the second housing portion 218. The sleeve 212 may be positioned so as to cover (i) the second housing portion 218 of the handle 202 and (ii) the shaft 204 of the electric toothbrush 200. A first end coupling portion 212A of the sleeve 212 may be receivably engaged with the first housing portion 206. A switch button 208 may be formed by the depressable biased connector 228 being received within a portion of the sleeve 212. The portion of the sleeve 212 extending about the depressable biased connector 228 of the second housing portion 218 may enable the depressable biased connector 228 to be in direct contact with the circuit board 226 when a compression force is applied. The circuit board 226 may be coupled to the motor 220 of the electric toothbrush 200 and configured to enable selective operation of the motor 220.

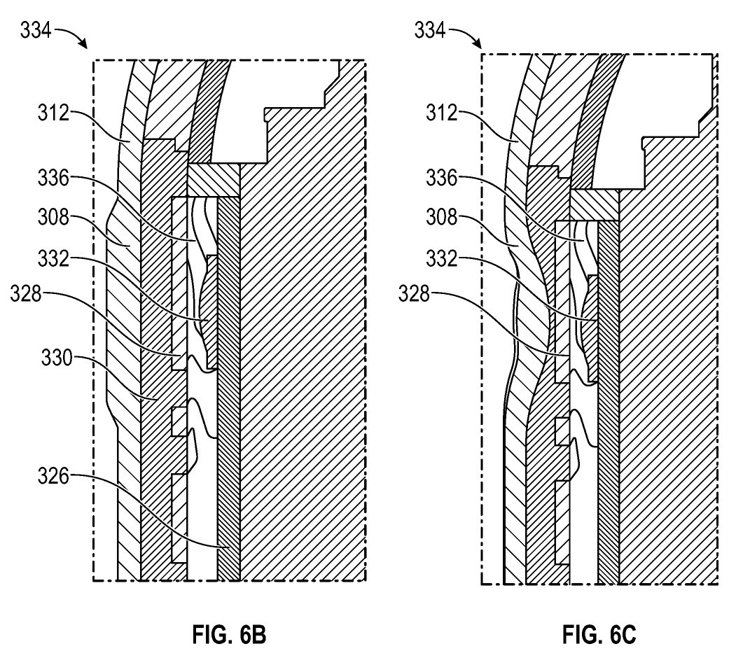

FIG. 6A shows a cross-sectional view of a portion of an electric toothbrush 300 in accordance with an example implementation of the present disclosure. As shown in FIG. 6A, the electric toothbrush 300 may include a handle 302. The handle 302 may include a first housing portion 306 and a second housing portion 318. The second housing portion 318 may be assembled with the first housing portion 306. In an example of FIG. 6A, a first end coupling portion 318A of the second housing portion 318 may be operatively engageable with, such as inserted into, the first housing portion 306. The electric toothbrush 300 may include a motor 320 disposed in a cavity within the second housing portion 318. The electric toothbrush 300 may include a shaft 304 extending from a second end coupling portion 318B of the second housing portion 318. The electric toothbrush 300 may include a sleeve 312. The sleeve 312 may cover the shaft 304 and the second housing portion 318. The second housing portion 318 may include one or more depressable biased connectors 328 that are configured to interoperate with a circuit board 326. In an example of FIG. 6A, a gap 330 may extend between the sleeve 312 and the one or more depressable biased connectors 328.

FIGS. 6B and 6C are expanded views of the electric toothbrush 300 in the region of 334 (identified in FIG. 6A). As shown in FIG. 6B, a button 308 is received (or included) in the sleeve 312 and is positioned proximal to the depressable biased connectors 328. Further, a switch button 336 may be positioned in the depressable biased connector 328 and further enable the depressable biased connector 328 to be in contact with the touch sensor 332 when a compression force is applied to the switch button 336. In the example implementation of FIG. 6B, the switch button 336 may be covered by the sleeve 312/button 308. A gap 330 may extend between (i) the sleeve 312 and (ii) the switch button 336 and/or the depressable biased connectors 328. As shown in FIG. 6C, a user may push (or press) the button 308 to cause the button 308 to bend toward the switch button 336. The switch button 336 may correspondingly transmit the force (or input) of the user received from the button 308 to the touch sensor 332. The touch sensor 332 may further electrically communicate with the circuit board 326 to cause the circuit board 326 to perform any one or more of various operations of the electric toothbrush 300 described herein.

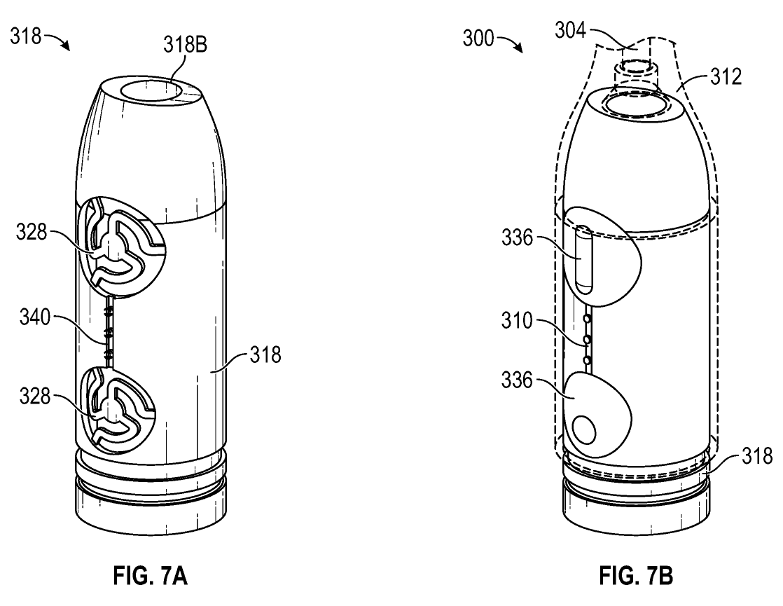

FIG. 7A is a perspective view of the second housing portion 318. As shown in FIG. 7A, the second housing portion 318 may include one or more depressable biased connectors 328. The second housing portion 318 may also include an opening 340. FIG. 7B is a perspective view of the electric toothbrush 300. As shown in FIG. 7B, a TPE material may be applied to fill the openings 340 and the one or more depressable biased connectors 328. The TPE material may extend through the one or more depressable biased connectors 328 and the opening 340 of the second housing portion 318 to enable the depressable biased connector 328 to make direct contact with the circuit board 326 and/or the touch sensor 332. The one or more switch buttons 336 and the indicator 310 may correspondingly be formed based on the TPE material positioned in the one or more depressable biased connectors 328 and the opening 340. The one or more switch buttons 336 and the indicator 310 may further be covered (or encompassed) by the sleeve 312. In an example implementation, a gap may extend between (i) the sleeve 312 and (ii) the one or more switch buttons 336 and the indicator 310.

In an example implementation, in order to assemble the electric toothbrush 300, the second housing portion 318 may be co-molded (or co-formed) with the TPE material such that the TPE material is molded at the positions of the opening 340 and the one or more depressable biased connectors 328 to form the one or more switch buttons 336 and the LED indicator 310 concurrently with the second housing portion 318. The sleeve 312 may further be formed separately. For example, the sleeve 312 may be molded by silicone. The sleeve 312 may be placed about the second housing portion 318 so as to cover the second housing portion318, the one or more switch buttons 336, and the LED indicator 310.

In an example implementation, in order to assemble the electric toothbrush 300, the second housing portion 318 may be formed (or molded) first. The TPE material may then be overmolded (or casted) to fill in the opening 340 and the one or more depressable biased connectors 328 to form the one or more switch buttons 336 and the LED indicator 310. A material with flexibility and elasticity, such as rubber or silicone, may be overmolded (or casted) to form the sleeve 312. The sleeve 312 may be further applied to cover the one or more switch buttons 336, the LED indicator 310, and the second housing portion 318. Thus, the sleeve 312 may be formed separately from the second housing portion 318 and the shaft 304, and then be assembled over the second housing portion 318 and the shaft 304 in any of the aforementioned configurations. Accordingly, the sleeve 312 could either be directly overmolded to the second housing portion 318 or the sleeve 312 could be molded separately and then assembled with the second housing portion 318.

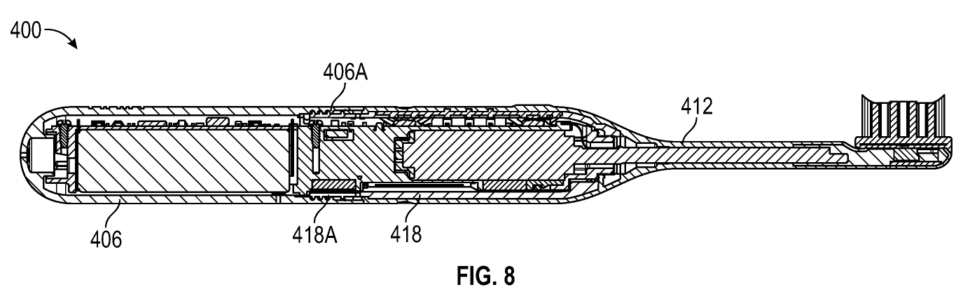

FIG. 8 shows another example of an electric toothbrush 400. As shown in FIG. 8, the electric toothbrush 400 may include a first housing portion 406 assembled with a second housing portion 418. A sleeve 412 is arranged to cover at least a portion of the second housing portion 418. In an example implementation, a mating coupling portion 406A of the first housing portion 406 and a first end coupling portion 418A of the second housing portion 418 may include screw threads. The screw threads on the mating coupling portion 406A of the first housing portion 406 and the first end coupling portion 418A of the second housing portion 418 allow the first and second housing portions to be screwably engaged. In an example implementation, glue may be applied between the mating coupling portion 406A of the first housing portion 406 and the first end coupling portion 418A of the second housing portion 418 as a secondary coupling method.

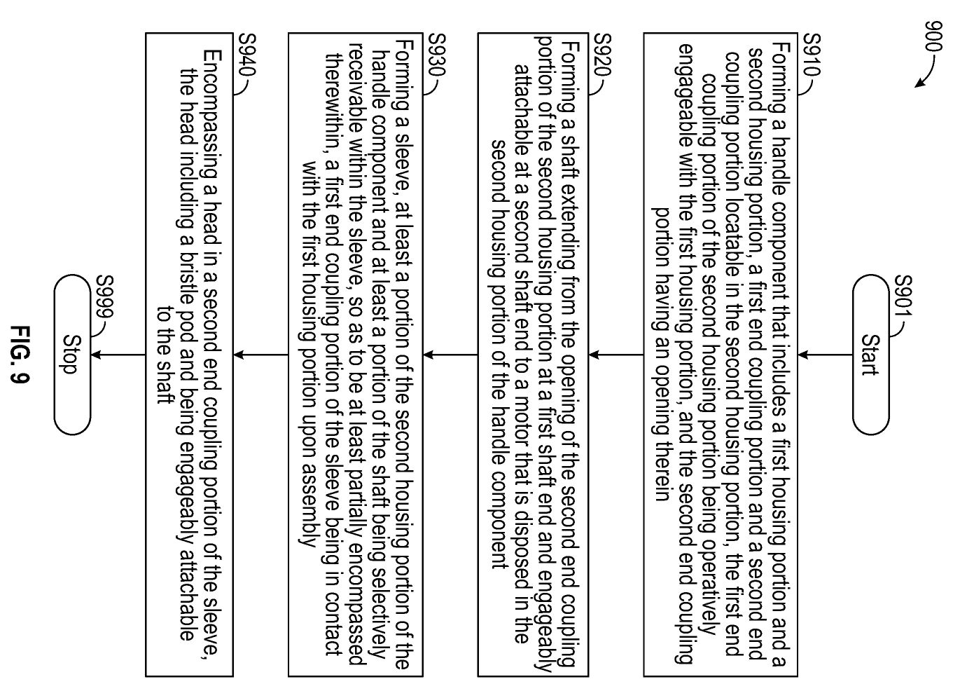

FIG. 9 shows a flow chart outlining a process (900) to manufacture an electric toothbrush according to an aspect of the disclosure. The process starts at (S901) and proceeds to (S910).

At (S910), a handle is formed/assembled. The handle includes a first housing portion and a second housing portion. A first end coupling portion of the top housing portion is assembled with the second housing portion.

At (S920), a shaft is located so as to extend from a second end coupling portion of the second housing portion of the handle and be engageably coupled to a motor that is disposed in the second housing portion of the handle.

At (S930), a sleeve is formed to cover (i) the second housing portion of the handle and (ii) the shaft of the electric toothbrush. A first end coupling portion of the sleeve is placed in contact with the first housing portion.

At (S940), a head is encompassed in a second end coupling portion of the sleeve. The head includes a bristle pod and is engageably attachable to the shaft.

In an aspect, a switch button may also be formed. The switch button may be configured to enable selective operation of the electric toothbrush and be positioned proximal to a depressable biased connector of the second housing portion of the handle. The depressable biased connector may be configured to span an opening in the second housing portion such that a circuit board in the second housing portion is readily engageable via the opening.

In an aspect, the switch button may be formed by filling the depressable biased connector with a portion of the sleeve such that the switch button is received in the sleeve. The portion of the sleeve may extend about the depressable biased connector of the second housing portion to enable, by depression of the switch button, the depressable biased connector to make direct contact with a circuit board. The circuit board may be operatively engaged with the motor of the electric toothbrush and configured to enable selective operation of the motor.

In an aspect, the switch button may be formed by filling the depressable biased connector with a thermoplastic elastomer (TPE) material such that the TPE material extends through the depressable biased connector of the second housing portion to enable the depressable biased connector to make contact with a circuit board when a compression force is applied to the switch button.

In an aspect, the first housing portion and the second housing portion are formed from a material harder than the sleeve.

In an aspect, the first housing portion and the second housing portion include one of nylon, glass filled nylon, acrylonitrile butadiene styrene (ABS), and polycarbonate, and the sleeve includes one of a silicone and a thermoplastic elastomer (TPE) material.

In an aspect, a gap is formed between (i) the sleeve and (ii) the switch button and the depressable biased connector of the second housing portion.

In an aspect, the sleeve and the first housing portion are made of two different materials.

In an aspect, an extension length of the first housing portion is equal to or larger than the second housing portion of the handle.

In an aspect, a depressable biased connector is formed in the second housing portion of the handle. The depressable biased connector includes (i) an opening to expose a circuity board in the second housing portion, (ii) a pad positionable proximal to a center of the opening, and (iii) a plurality of extensions in contact with the pad and an edge of the opening.

Then, the process proceeds to (S999) and terminates.

The process (900) can be suitably adapted. Step(s) in the process (900) can be modified and/or omitted. Additional step(s) can be added. Any suitable order of implementation can be used.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. An electric toothbrush, comprising:
a handle component having a first housing portion and a second housing portion, a first end coupling portion and a second end coupling portion locatable in the second housing portion, the first end coupling portion being operatively engageable with the first housing portion, and the second end coupling portion having an opening therein;
a motor receivable within the second housing portion;
a shaft receivable within the handle component via the opening in the second end coupling portion, the shaft being selectively operatively engageable with the motor when disposed within the second housing portion;
a head selectively operatively engageable with the shaft, the head configured to interoperate with a bristle pod; and
a sleeve, at least a portion of the second housing portion of the handle component and at least a portion of the shaft being selectively receivable within the sleeve, so as to be at least partially encompassed therewithin.

2. The electric toothbrush of claim 1, wherein the first housing portion and the second housing portion include a material that is less flexible or resilient than a material including at least some portions of the sleeve.

3. The electric toothbrush of claim 1, wherein:
at least some features of the first housing portion and the second housing portion comprise of materials that include one of nylon, glass filled nylon, acrylonitrile butadiene styrene (ABS), and polycarbonate, and
features of the sleeve comprise materials that include one of a silicone and a thermoplastic elastomer (TPE) material.

4. The electric toothbrush of claim 1, further comprising:
a switch button that is configured to enable selective operation of the electric toothbrush and positionable proximal to a depressable biased connector of the second housing portion of the handle component, the depressable biased connector being configured to provide an opening in the second housing portion such that a circuity board in the second housing portion is readily engageable via the opening.

5. The electric toothbrush of claim 4, the switch button is received in the sleeve such that a portion of the sleeve further extends through the depressable biased connector of the second housing portion to enable the depressable biased connector to make contact with a circuit board when a compression force is applied to the switch button, the circuit board being configured to enable selective operation of the motor.

6. The electric toothbrush of claim 4, wherein the switch button is made of a thermoplastic elastomer (TPE) material and covered by the sleeve, the TPE material extending through the depressable biased connector of the second housing portion so as to enable the depressable biased connector to be contactable with one or more features of a circuit board when a compression force is applied to the switch button.

7. The electric toothbrush of claim 6, wherein a gap is extended between (i) the sleeve and (ii) the switch button and the depressable biased connector of the second housing portion when the switch button is in an unengaged position.

8. The electric toothbrush of claim 1, wherein the sleeve and the first housing portion comprise two different materials.

9. The electric toothbrush of claim 1, wherein the sleeve includes a first end coupling portion in which the head is encompassed and a second end coupling portion in contact with the first housing portion of the handle component.

10. The electric toothbrush of claim 1, wherein an extension length of the first housing portion is equal to or larger than an extension length of the second housing portion of the handle component.

11. A method of manufacturing an electric toothbrush, the method comprising:
forming a handle component that includes a first housing portion and a second housing portion, a first end coupling portion and a second end coupling portion locatable in the second housing portion, the first end coupling portion of the second housing portion being operatively engageable with the first housing portion, and the second end coupling portion having an opening therein;
forming a shaft extending from the opening of the second end coupling portion of the second housing portion at a first shaft end and engageably attachable at a second shaft end to a motor that is disposed in the second housing portion of the handle component;
forming a sleeve, at least a portion of the second housing portion of the handle component and at least a portion of the shaft being selectively receivable within the sleeve, so as to be at least partially encompassed therewithin, a first end coupling portion of the sleeve being in contact with the first housing portion upon assembly; and
encompassing a head in a second end coupling portion of the sleeve, the head including a bristle pod and being engageably attachable to the shaft.

12. The method of claim 11, further comprising:
forming a switch button that is configured to enable selective operation of the electric toothbrush and positionable proximal to a depressable biased connector of the second housing portion of the handle component, the depressable biased connector being configured to form an opening in the second housing portion such that a circuity board in the second housing portion is readily engageable via the opening.

13. The method of claim 12, wherein the forming the switch button further comprises:
forming the switch button by filling the depressable biased connector
with a portion of the sleeve such that the switch button is received in the sleeve, the portion of the sleeve extending through the depressable biased connector of the second housing portion to enable the depressable biased connector to make contact with a circuit board when a compression force is applied to the switch button, the circuit board being configured to enable selective operation of the motor.

14. The method of claim 12, wherein the forming the switch button further comprises:
forming the switch button by filling the depressable biased connector with a thermoplastic elastomer (TPE) material such that the TPE material extends through the depressable biased connector of the second housing portion to enable the depressable biased connector to make contact with a circuit board when a compression force is applied to the switch button, and the switch button being covered by the sleeve.

15. The method of claim 11, wherein the first housing portion and the second housing portion include a material that is less flexible or resilient than a material including at least some portions of the sleeve.

16. The method of claim 11, wherein:
at least some features of the first housing portion and the second housing portion comprise of materials that include one of nylon, glass filled nylon, acrylonitrile butadiene styrene (ABS), and polycarbonate, and
features of the sleeve comprise materials that include one of a silicone and a thermoplastic elastomer (TPE) material.

17. The method of claim 14, wherein a gap is extended between (i) the sleeve and (ii) the switch button and the depressable biased connector of the second housing portion when the switch button is in an unengaged position.

18. The method of claim 11, wherein the sleeve and the first housing portion are made of two different materials.

19. The method of claim 11, wherein an extension length of the first housing portion is equal to or larger than an extension length of the second housing portion of the handle component.

20. The method of claim 11, further comprising:
forming a depressable biased connector in the second housing portion of the handle component, the depressable biased connector including (i) an opening to expose a circuity board in the second housing portion, (ii) a pad positionable proximal to a center of the opening, and (iii) a plurality of extensions in contact with the pad and an edge of the opening.
